(19) United States
(12) Patent Application Publication
(10) Pub. No.: US 2023/0315745 A1
(43) Pub. Date: Oct. 5, 2023

(54) INFORMATION PUSHING METHOD, APPARATUS, DEVICE, STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Guangben LU, Shenzhen (CN); Wei WANG, Shenzhen (CN); Yanrong KANG, Shenzhen (CN); Ao TAN, Shenzhen (CN); Xiaolong ZHAI, Shenzhen (CN); Xiaojie QIU, Shenzhen (CN); Xianwen YU, Shenzhen (CN); Yao ZHAI, Shenzhen (CN); Lin HE, Shenzhen (CN); Feng ZHANG, Shenzhen (CN); Yujie LU, Shenzhen (CN); Jing LAN, Shenzhen (CN); Xiaofeng GAO, Shenzhen (CN); Rongli WU, Shenzhen (CN); Jiaojian KANG, Shenzhen (CN)

(73) Assignee: TENCENT TECHNOLOGY (SHENZHEN) COMPANY LIMITED, Shenzhen (CN)

(21) Appl. No.: 18/332,398

(22) Filed: Jun. 9, 2023

Related U.S. Application Data
(63) Continuation of application No. PCT/CN2022/102583, filed on Jun. 30, 2022.

(30) Foreign Application Priority Data
Aug. 5, 2021 (CN) 202110898411.7

(51) Int. Cl. G06F 16/2457

(52) U.S. Cl. CPC G06F 16/24578

(57) ABSTRACT

An information pushing method, apparatus, device, storage medium, and computer program product are provided, relating to the technical field of Internet applications. The method includes: extracting an information feature of candidate information, the information feature including a coarse-grained feature and a fine-grained feature; obtaining a first feature of the candidate information based on an intermediate feature obtained in a process of extracting the coarse-grained feature; obtaining a second feature of the candidate information based on the information feature and the intermediate feature; obtaining target information based on the first feature and the second feature; and pushing the target information.

### CROSS-REFERENCE TO RELATED APPLICATIONS

This application is a bypass continuation application of International Patent Application No. PCT/CN2022/102583, filed on Jun. 30, 2022, which is based on and claims priority to Chinese Patent Application No. 202110898411.7, filed with the China National Intellectual Property Administration on Aug. 5, 2021, the disclosures of which are incorporated by reference herein in their entireties.

### FIELD

The present disclosure relates to the technical field of Internet applications, and more particularly, to information pushing.

### DESCRIPTION OF RELATED ART

In the field of Internet information pushing, in order to improve the accuracy of information pushing, an information push platform may usually use a machine learning model to select information to be pushed.

In the related art, when information is be pushed, the information pushing platform inputs an information feature of each information that may be pushed into a trained probability estimation model to obtain an estimated probability (for example, an estimated conversion rate) of a specified event after the information is pushed and displayed, and then determines the information pushed this time according to the estimated conversion rate of each information.

However, in an information pushing scene, the determined estimated conversion rate is different from an actual situation, thereby affecting the accuracy of information pushing.

### SUMMARY

Embodiments of the disclosure provide an information pushing method and apparatus, a computer device, and a storage medium, which may improve the accuracy of information pushing. The technical solution is as follows:

In accordance with certain embodiments of the present disclosure, an information pushing method performed by at least one processor is provided. The method includes extracting an information feature of candidate information, the information feature comprising a coarse-grained feature and a fine-grained feature, a number of tail value samples of the coarse-grained feature being greater than a number of tail value samples of the fine-grained feature; obtaining a first feature of the candidate information based on an intermediate feature, the intermediate feature being obtained in a process of extracting the coarse-grained feature; obtaining a second feature of the candidate information based on the information feature and the intermediate feature; obtaining target information from a plurality of pieces of candidate information, based on the first feature and the second feature; and pushing the target information.

In accordance with other embodiments of the present disclosure, an information pushing apparatus is provided, and includes at least one memory configured to store program code and at least one processor configured to read the program code and operate as instructed by the program code. The program code includes information feature extraction code, configured to cause the at least one processor to extract information feature of candidate information, the information feature comprising a coarse-grained feature and a fine-grained feature, a number of tail value samples of the coarse-grained feature being greater than a number of tail value samples of the fine-grained feature; first feature obtaining code, configured to cause the at least one processor to obtain a first feature of the candidate information based on an intermediate feature, the intermediate feature being obtained in a process of extracting the coarse-grained feature; second feature obtaining code, configured to cause the at least one processor to obtain a second feature of the candidate information based on the information feature and the intermediate feature; information obtaining code, configured to cause the at least one processor to obtain target information from a plurality of pieces of the candidate information based on the first feature and the second feature; and information pushing code, configured to cause the at least one processor to push the target information.

In accordance with still other embodiments of the present disclosure, a non-transitory computer-readable storage medium storing at least one computer instruction is provided. The at least one computer instruction is executable by at least one processor to cause the at least one processor to extract an information feature of candidate information, the information feature comprising a coarse-grained feature and a fine-grained feature, a number of tail value samples of the coarse-grained feature being greater than a number of tail value samples of the fine-grained feature; obtain a first feature of the candidate information based on an intermediate feature, the intermediate feature being obtained in a process of extracting the coarse-grained feature; obtain a second feature of the candidate information based on the information feature and the intermediate feature; obtain target information from a plurality of pieces of candidate information, based on the first feature and the second feature; and push the target information.

It is to be understood that, the foregoing general descriptions and the following detailed descriptions are merely for illustration and explanation purposes and are not intended to limit the disclosure.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a system configuration diagram of an information pushing system according to various embodiments of the disclosure;

FIG. 2 is a flowchart of an information pushing method according to an exemplary embodiment of the disclosure;

FIG. 3 is a schematic diagram of a tail value of a feature according to the embodiment shown in FIG. 2.

FIG. 4 is a flowchart of an information pushing method according to an exemplary embodiment of the disclosure;

FIG. 5 is a model architectural diagram according to the embodiment shown in FIG. 4;

FIG. 6 is a schematic diagram illustrating weighting summation on expert information according to the embodiment shown in FIG. 4;

FIG. 7 is a schematic diagram illustrating obtaining a second weight according to the embodiment shown in FIG. 4;

FIG. 8 is a data chart of comparative experiment results according to the embodiment shown in FIG. 4;

FIG. 9 is a data chart of ablation experiment results according to the embodiment shown in FIG. 4;

FIG. 10 is a structural block diagram of an information pushing apparatus according to an exemplary embodiment of the disclosure; and

FIG. 11 is a schematic structural diagram of a computer device according to an exemplary embodiment of the disclosure.

### DETAILED DESCRIPTION

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with the disclosure. On the contrary, the implementations are merely examples of apparatuses and methods that are recited in detail in the appended claims and that are consistent with some aspects of the disclosure.

Before describing the various embodiments shown in the disclosure, several concepts involved in the disclosure are first introduced.

1) Artificial Intelligence (AI)

AI is a theory, method, technology, and application system that use a digital computer or a machine controlled by a digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that may react in a manner similar to human intelligence. AI is to study the design principles and implementation methods of various intelligent machines, to enable the machines to have the functions of perception, reasoning, and decision-making. The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

2) Machine Learning (ML)

ML is a multi-field interdiscipline, and relates to a plurality of disciplines such as the probability theory, statistics, approximation theory, convex analysis, and algorithm complexity theory. ML specializes in studying how a computer simulates or implements a human learning behavior to obtain new knowledge or skills, and reorganize an existing knowledge structure, so as to keep improving its performance. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstrations.

3) Big Data

“Big Data” refers to a data set that cannot be captured, managed and processed by conventional software tools in a certain time range, and is a massive, high-growth and diversified information asset that instead uses newer processing modes to have stronger decision-making power, insight and discovery ability and process optimization ability. With the advent of the cloud era, big data also has attracted more and more attentions. Big data uses special technology to effectively process a large amount of data that has been collected for a long time. Technologies suitable for big data processing include a large-scale parallel processing database, data mining, a distributed file system, a distributed database, a cloud computing platform, an Internet, and an extensible storage system.

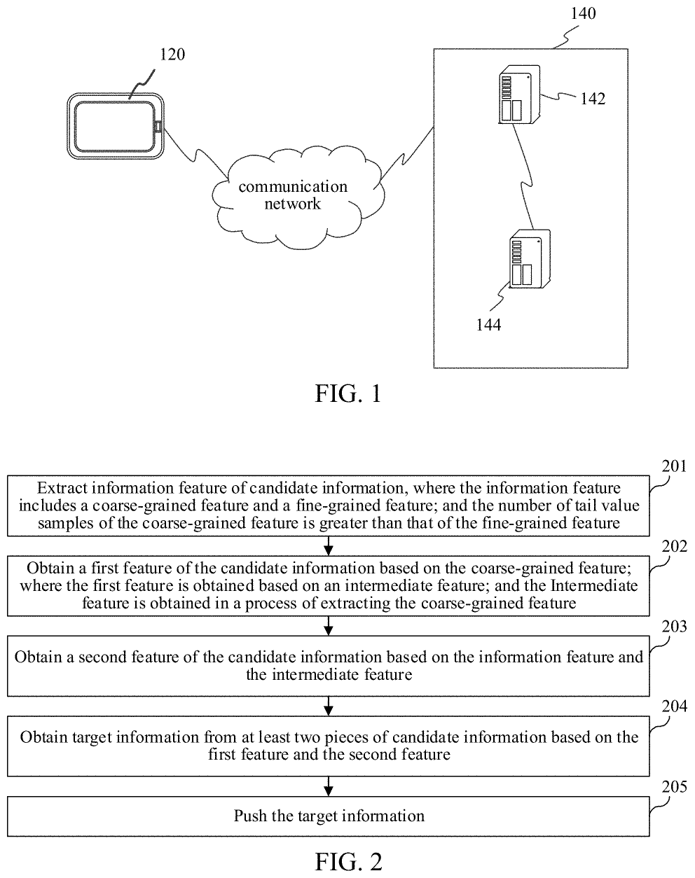

FIG. 1 shows a system configuration diagram of an information pushing system according to various embodiments of the disclosure. As shown in FIG. 1, the system includes: a user terminal 120 and a server 140.

The user terminal 120 may be a mobile phone, a tablet computer, an e-book reader, a Moving Picture Experts Group Audio Layer III (MP3) player, a Moving Picture Experts Group Audio Layer IV (MP4) player, a smart wearable device, a laptop portable computer, a desktop computer, and the like.

The user terminal 120 is connected to the server 140 through a communication network. Optionally, the communication network is a wired network or a wireless network.

The server 140 may be an independent physical server, may also be a server cluster or a distributed system composed of multiple physical servers, and may further be a cloud server that provides basic cloud computing services such as cloud services, cloud databases, cloud computing, cloud functions, cloud storage, network services, cloud communication, middleware services, domain name services, security services, Content Delivery Network (CDN), and big data and artificial intelligence platforms.

Optionally, the server 140 may include a server configured to implement an information delivery platform 142. Optionally, the server 140 may further include a server configured to implement an information pushing platform 144.

Optionally, the information delivery platform 142 has functions of pushing and maintaining an information delivery interface, and receiving information delivered by an information delivery person.

The information above is information that may be displayed in many different applications at the same or similar times, such as an advertisement. As used herein, the term “advertisement” may include a non-economic advertisement and an economic advertisement, and the term “non-economic advertisement” refers to an advertisement not for the purpose of profit, which is also known as an effect advertisement, such as various announcements, notices, and statements of government administrative departments, social institutions, and even individuals; the term “economic advertisement” is also known as a “commercial advertisement”, and refers to an advertisement for the purpose of profit.

Optionally, the information pushing platform 144 has functions of managing and maintaining messages and pushing information to user terminals.

It should be noted that, the servers for implementing the information delivery platform 142 and the information pushing platform 144 may be servers independent from each other, and may also be implemented in a same physical server.

Optionally, the system may further include a management device (not shown in the drawing), which is connected with the server 140 through the communication network. Optionally, the communication network is a wired network or a wireless network.

Optionally, the wireless network or the wired network uses a standard communications technology and/or protocol. The network is usually the Internet, but may be any other network, including but not limited to a Local Area Network (LAN), a Metropolitan Area Network (MAN), a Wide Area Network (WAN), a mobile, wired, or wireless network, a dedicated network or a virtual dedicated network, or any combination thereof. In some embodiments, data exchanged by using a network may be represented by using a technology and/or format such as a Hyper Text Mark-up Language (HTML) and an Extensible Markup Language (XML). In addition, all or some links may be encrypted by using conventional encryption technologies such as a Secure Socket Layer (SSL), a Transport Layer Security (TLS), a Virtual Private Network (VPN), and Internet Protocol Security (IPsec). In some other embodiments, customized and/or dedicated data communication technologies may also be used to replace or supplement the foregoing data communication technologies.

FIG. 2 is a flowchart of an information pushing method according to an exemplary embodiment. The method may be executed by a computer device, for example, the computer device may be a server, where the server may be the server 140 in the embodiment shown in FIG. 1. As shown in FIG. 2, the information pushing method may include the following operations:

Operation 201. Extract an information feature of candidate information, the information feature including a coarse-grained feature and a fine-grained feature; where the number of tail value samples of the coarse-grained feature is greater than that of the fine-grained feature.

As used herein, a “tail value” of the feature refers to a feature value corresponding to one or more categories arranged at a tail position of a queue after each sample information is classified according to each feature value of a certain feature and sorted according to an order of the number of information in each category from large to small, for example, it may be a feature value which is arranged at the tail position of the queue and has the corresponding number of information less than a quantity threshold. That is to say, the number of the tail value samples above is the number of sample information arranged in the category of the tail position of the queue.

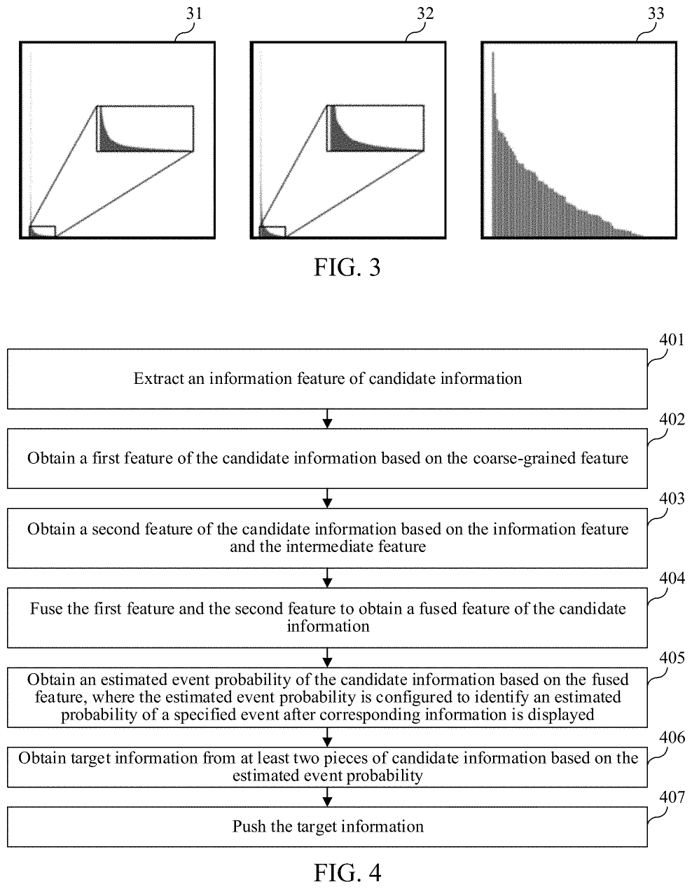

For example, FIG. 3 shows a schematic diagram of the feature tail value according to an embodiment of the disclosure. Taking the information being an advertisement as an example, FIG. 3 includes a sample number histogram 31 corresponding to feature 1 (e.g., an advertisement Identity (ID)), a sample number histogram 32 corresponding to feature 2 (e.g., an advertiser), and a sample number histogram 33 corresponding to feature 3 (e.g., a product type corresponding to the advertisement).

In the sample number histogram 31 corresponding to the advertisement ID in FIG. 3, an ordinate may represent click/exposure/conversion times of the advertisement corresponding to the advertisement ID, and an abscissa represents each advertisement ID. Many new advertisements would be generated in the Internet, therefore, in the sample number histogram corresponding to the advertisement ID, the sample number corresponding to each advertisement ID at the tail is very small. For example, the maximum/minimum/average value of the sample number corresponding to each advertisement ID at the tail may be less than 100, and therefore, this feature, i.e., the advertisement ID, may be listed as a fine-grained feature.

For another example, in the sample number histogram 32 corresponding to the advertiser in FIG. 3, the ordinate may represent the number of click/exposure/conversion times of the advertisement corresponding to the advertiser, and the abscissa represents the ID of each advertiser. There are many small advertisers on the Internet, and the number of advertisements placed by these advertisers is very small, therefore, in the sample number histogram corresponding to the advertiser ID, the sample number corresponding to each advertiser at the tail is very small. For example, the maximum/minimum/average value of the sample number corresponding to each advertiser at the tail may be less than 100. Therefore, this feature, i.e., the advertiser ID, may also be listed as a fine-grained feature.

For another example, in the sample number histogram 33 corresponding to a product type in FIG. 3, the ordinate may represent the click/exposure/conversion times of the advertisement corresponding to each product type, and the abscissa represents each product type. The number of product types corresponding to the advertisement on the Internet is limited, and there are usually a large amount of advertisements for each product type. Therefore, even the product type at the tail corresponds to a large number of samples. For example, the maximum/minimum/average number of samples corresponding to each product type at the tail may be greater than 1000. Therefore, this feature, i.e., the product type, may be listed as a coarse-grained feature.

Herein, the above three features, i.e., the advertisement ID, the advertiser ID, and the product type, are presented as examples to introduce and explain division of the coarse-grained and fine-grained features, but this is for convenience and clarity purposes, and it is noted that the principles disclosed herein are generally applicable to other features.

The coarse-grained and fine-grained features may be manually divided by developers according to the number of tail samples of each feature, or the coarse-grained and fine-grained features may also be automatically divided by a computer device based on statistical results of the number of tail samples of each feature according to division rules set by developers, which is not limited in the embodiments of the disclosure.

In an embodiment of the disclosure, when there is an information displaying opportunity, the computer device may obtain each information satisfying the information displaying opportunity as a group of candidate information, and extract the information features of these candidate information, where these information feature are divided into the coarse-grained feature and the fine-grained feature.

Operation 202. Obtain a first feature of candidate information based on the coarse-grained feature; where the first feature is obtained based on an intermediate feature; and the intermediate feature is obtained in a process of extracting the coarse-grained feature.

In an embodiment of the disclosure, for the coarse-grained feature of each candidate information, the computer device may further extract these coarse-grained features. For example, the computer device first performs feature extraction on the coarse-grained feature to obtain the intermediate feature, and then further processes the intermediate feature corresponding to the coarse-grained feature to obtain the first feature.

Operation 203. Obtain a second feature of the candidate information based on the information feature and the intermediate feature.

In an embodiment of the disclosure, in order to extract more accurate feature characterization, when extracting the second feature from the candidate information, besides using the information feature of the candidate information, the intermediate feature of the candidate information is also shared, so that the multi-level feature characterization in the candidate information (an information whole level, a coarse-grained feature level, and a fine-grained feature level) may be learned.

Operation 204. Obtain target information from at least two pieces of candidate information based on the first feature and the second feature.

Operation 205. Push the target information.

To sum up, in various embodiments of the disclosure, the information feature is divided into the coarse-grained feature with a large number of tail value samples and the fine-grained feature with a small number of tail value samples, the first feature is extracted from the coarse-grained feature, and the second feature is extracted from the information feature including the coarse-grained feature and the fine-grained feature. When extracting the second feature, the second feature is extracted by combining the intermediate feature between the coarse-grained feature and the first feature. Multi-level feature characterization is synchronously learned from the information feature, so that the characterization effect of the extracted feature on the candidate information at multiple granularities may be improved, the target information for pushing may be accurately obtained from the candidate feature through the first feature and the second feature, and the accuracy of information pushing may be improved.

In an embodiment of the disclosure, the method shown in FIG. 2 may be realized by a trained probability estimation model.

FIG. 4 is a flowchart of an information pushing method according to an exemplary embodiment of the disclosure. The method may be executed by a computer device, for example, the computer device may be a server, and the server may be the server 140 in an embodiment shown in FIG. 1. As shown in FIG. 4, the information pushing method may include the following operations:

Operation 401. Extract information feature of candidate information.

Operation 401 may be equivalent to Operation 201 in the embodiment shown in FIG. 2, and will not be repeated herein.

Operation 402. Obtain a first feature of candidate information based on the coarse-grained feature.

In an embodiment of the disclosure, when the computer device extracts the first feature, it may first perform feature extraction on the coarse-grained feature to obtain multiple intermediate features, and then weight the multiple intermediate features to obtain the first feature.

For example, the process of obtaining the first feature of the candidate information based on the coarse-grained feature may include:
performing feature extraction on the coarse-grained feature to obtain m first intermediate features of the candidate information; where m is a positive integer (that is, at least one first intermediate feature is obtained);
obtaining a first weight of the m first intermediate features based on the coarse-grained feature; and
obtaining a first feature of the candidate information based on the m first intermediate features and the first weight of the m first intermediate features.

For each candidate information, the computer device may conduct the processes above, respectively, that is, it may obtain the first feature corresponding to each candidate information.

For example, in an embodiment of the disclosure, the m first intermediate features may be extracted from the coarse-grained feature by preset m expert networks, and the computer device also obtains the first weight corresponding to the m first intermediate features based on the coarse-grained feature, and then weights the m first intermediate features based on the first weight to obtain the first feature of each candidate information.

By determining the first weight of the first intermediate feature, when obtaining the first feature of the candidate information, an importance degree of each first intermediate feature with respect to the first feature may be determined based on the first weight respectively corresponding to m first intermediate features, which facilitates to improve the accuracy of the first feature, so as to perform feature characterization on the coarse-grained feature level more accurately.

In one possible implementation, the process of obtaining the first feature of candidate information based on the coarse-grained feature may include: processing the coarse-grained feature through a first extraction branch in the probability estimation model to obtain the first feature.

The first extraction branch may include three parts: a feature extraction network, a weight obtaining network, and a weighting network.

In an exemplary solution, the feature extraction network may include m expert networks, which respectively process the input coarse-grained feature and respectively output a copy of expert information (i.e., the first intermediate feature).

In an exemplary solution, the weight obtaining network may be a gate network, and the gate network in the first extraction branch may process the input coarse-grained feature and output the weights respectively corresponding to m expert networks (i.e., the first weights).

In an exemplary solution, the weighting network may be realized by including a weighting layer and a tower-shaped network. The weighting layer of the weighting network in the first extraction branch may perform weighting summation on the expert information output by the m expert networks based on the weights output by the gate network in the first extraction branch, and the tower-shaped network of the weighting network in the first extraction branch may extract the features of the weighting summation results of the weighting layers by means of knowledge distillation to obtain the first feature output by the first extraction branch.

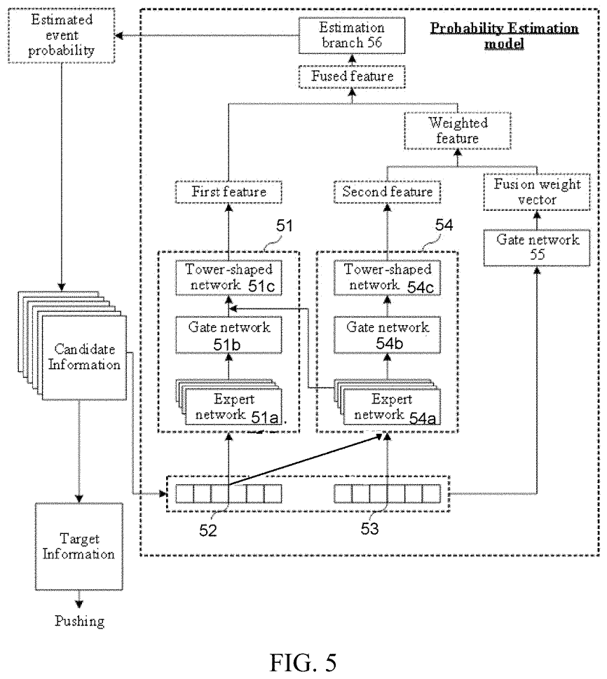

FIG. 5 shows the model frame diagram according to an embodiment of the disclosure. As shown in FIG. 5, the probability estimation model includes a first extraction branch 51, which includes m expert networks 51a, a gate network 51b, and a tower-shaped network 51c.

In an embodiment of the disclosure, the first extraction branch may also be called a grouping layer. The purpose of the existence of the grouping layer is to learn generalized characterization of each information group, which contains common knowledge transmitted among all information in the group. In FIG. 5, the first extraction branch 51 partially shows constituent elements of the grouping layer. The bottom layer is composed of some expert networks (expert networks 51a), which take the coarse-grained feature 52 as an input and specific expert information as an output. Different expert information corresponds to different aspects of tasks; the expert information may be shared among different tasks.

In an embodiment of the disclosure, the expert network may be composed of a single-layer neural network, and a Rectified Linear Unit (ReLU) is adopted as an activation function. For example, the output of the expert network at the grouping layer may be represented as:

t_{g}^{k}=ReLU(W₁^{K}x_{g})

where W₃^{K}∈ [symbol] is the input feature of the grouping layer, and W₃^{K}∈ [symbol] represents a coefficient matrix that a k-th expert network maps the input feature from an initial embedding space W₃^{K}∈ [symbol] to a new space W₃^{K}∈ [symbol] .

In order to self-adaptively fuse the expert networks, in the framework shown in FIG. 5, a gate network 51b is also used for selective fusion. In an embodiment of the disclosure, the gate network may be composed of a single-layer neural network, with softmax as the activation function, and its output may be represented as:

w_{g}=Softmax(W₂x_{g})

W₃^{K}∈ [symbol] is the coefficient matrix, and m is the number of expert networks in the grouping layer.

In the first extraction branch 51 shown in FIG. 5, after weighting summation of expert information on the expert information at an upper structure, the characterization vector of the grouping layer is distilled by the tower network, and the characterization vector is as follows:

$${e}_{g} = {h}_{g} ( {f}_{g} )$$

$${f}_{g} = {\sum }_{k = 1}^{m} {w}_{g}^{k} {t}_{g}^{k}$$

h_{g} stands for the tower-shaped network of grouping layer.

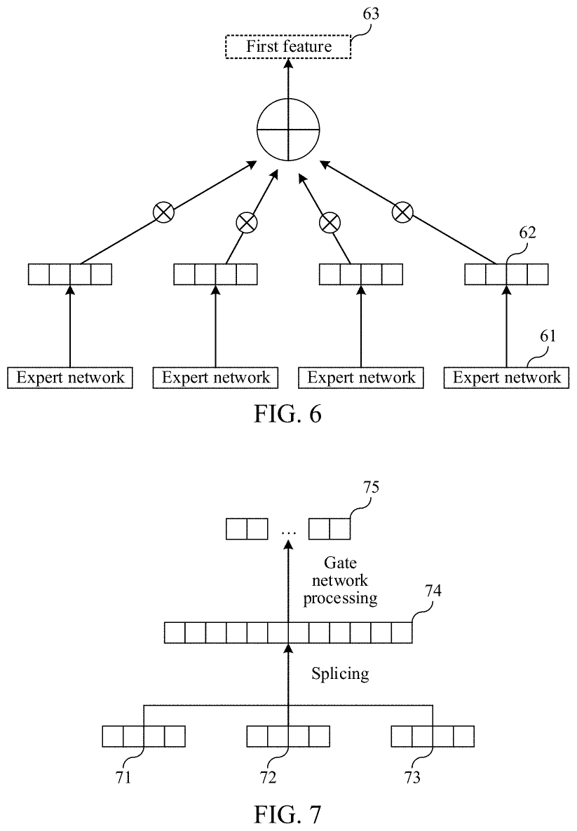

FIG. 6 shows a schematic diagram of weighting summation of the expert information according to an embodiment of the disclosure. As shown in FIG. 6, m expert networks 61 (four expert networks are shown in FIG. 6) respectively output expert information 62, and the m expert information 62 is multiplied by their respective first weights through a weighting layer (not shown in FIG. 6), then added, and then processed through the tower-shaped network to obtain the first feature 63.

Operation 403. Obtain a second feature of the candidate information based on the information feature and the intermediate feature.

An embodiment of the disclosure adopts an asymmetric feature sharing processing mode to extract features, where the asymmetric feature sharing mode refers to an intermediate feature obtained in the process of sharing the first feature when extracting the second feature.

In one possible implementation, the process of obtaining the second feature of the candidate information based on the information feature and the intermediate feature may be as follows:
performing feature extraction on the information feature to obtain n second intermediate features of the candidate information; where n is a positive integer (that is, at least one second intermediate feature is obtained);
obtaining a second weight of the n second intermediate features and a second weight of the m first intermediate features based on the information feature; and
obtaining a second feature of the candidate information based on the second weight of the n second intermediate features, the second weight of the m first intermediate features, the n second intermediate features, and the m first intermediate features.

For each candidate information to be processed, the computer device may conduct the processes above, respectively, that is, the second feature corresponding to each candidate information may be obtained.

For example, in an embodiment of the disclosure, the n second intermediate features may be obtained by respectively extracting the coarse-grained feature and the fine-grained feature by the preset n expert networks, and the computer device also obtains second weights respectively corresponding to the n second intermediate features based on the coarse-grained feature and the fine-grained feature. In addition, the computer device also obtains second weights respectively corresponding to the m first intermediate features based on the coarse-grained feature and the fine-grained feature, and then, further based on the second weights, the m first intermediate features and the n second intermediate features are weighted to obtain the second feature of each candidate information.

By determining the second weights of the first intermediate feature and the second intermediate feature with respect to the information feature, respectively, when obtaining the second feature of the candidate information, the importance degree of each first intermediate feature and the second intermediate feature with respect to the second feature and the influence size when determining the second feature may be determined based on the second weights respectively corresponding to the m first intermediate features and n second intermediate features, which facilitates to improve the accuracy of the second feature, so that the overall information level, coarse-grained feature level and fine-grained feature level may be characterized more accurately.

In one possible implementation, the process of obtaining the second weight of n second intermediate features and the second weight of m first intermediate features based on information feature may include:
obtaining a second weight of the n second intermediate features and a second weight of the m first intermediate features based on the information feature and a popularity vector of the candidate information; where the popularity vector is used for indicating historical conversion times of the candidate information.

In an embodiment of the disclosure, in order to learn the features of candidate information more accurately to improve the accuracy of subsequent information pushing, the popularity of each candidate information may also be considered when obtaining the second weight.

In one possible implementation, the process of obtaining the second weight of n second intermediate features and the second weight of m first intermediate features based on the information feature and popularity vector of candidate information may include:
splicing the information feature and the popularity vector to obtain a first spliced feature of the candidate information; and
obtaining the second weight of the n second intermediate features and the second weight of the m first intermediate features based on the first spliced feature.

In an embodiment of the disclosure, the computer device may splice the fine-grained feature, the coarse-grained feature and the popularity vector of the candidate information, and then process the spliced feature to obtain the second weight. Through feature splicing, the information carried by the popularity vectors may be better integrated into the fine-grained feature and the coarse-grained feature, so as to effectively determine the accurate second weight according to the popularity feature.

In one possible implementation, the process of obtaining the second feature of the candidate information based on the information feature and the intermediate feature may include:
processing the information feature and the intermediate feature through a second extraction branch in the probability estimation model to obtain the second feature;
where the second extraction branch may also include three parts: a feature extraction network, a weight obtaining network, and a weighting network.

In an exemplary solution, the feature extraction network in the second extraction branch may include n expert networks, which respectively process the input information feature (the coarse-grained feature+the fine-grained feature) and respectively output a copy of expert information (i.e., the second intermediate feature).

In an exemplary solution, the weight obtaining network in the second extraction branch may be a gate network, and the gate network in the second extraction branch may process the input information feature and output the m expert networks in the second extraction branch and the weights corresponding to the n expert networks in the first extraction branch (i.e., the second weight).

In an exemplary solution, the weighting network may be realized by including a weighting layer and a tower-shaped network. The weighting layer in the second extraction branch may perform weighting summation on the expert information output by m+n expert networks based on the weights output by the gate network in the second extraction branch, and the tower-shaped network of the weighting network in the second extraction branch may extract the features of the weighting summation results of the weighting layer by means of knowledge distillation to obtain the second feature output by the second extraction branch.

As shown in FIG. 5, the probability estimation model includes a second extraction branch 54, and the second extraction branch 54 includes n expert networks 54a, a gate network 54b and a tower-shaped network 54c.

In the implementation of the disclosure, the second extraction branch in FIG. 5 may also be called the information layer. In FIG. 5, the information layer and the grouping layer share a part of an underlying structure, which may better learn the differences among individual information. As shown in the structure of the second extraction branch 54 in FIG. 5, the input of the information layer not only includes the coarse-grained feature 52, but also expands to the fine-grained feature 53. Therefore, the outputs of n expert networks 54a may be represented as:

tₐ^{k}=ReLU(W₃^{K}xₐ)

xₐ∈ [symbol] is the input feature of the information layer, and W₃^{K}∈ [symbol] is the transformation matrix of the k-th expert network.

In the information layer shown in FIG. 5, the expert networks of the information layer and the grouping layer are not separated, but are combined and sent to the tower-shaped network for distillation of characterization information. This asymmetric information sharing design mode may greatly improve the representation performance of the whole model.

In addition, in an embodiment of the disclosure, the information with rich positive samples is also distinguished from the new information with a few positive samples through the historical conversion times of information. In order to let the model learn the differences between the popularity of this information, display definition and construction are performed on the characterization thereof in the gate network of the information layer.

For example, in an embodiment of the disclosure, popularity is first divided into buckets according to a numerical range, and each bucket is characterized and learned. Considering an oligopoly effect of popularity, the numerical range of buckets would be expanded with the increase of popularity.

For example, the computer device may divide the numerical range of popularity into r numerical intervals end to end, where for a certain piece of candidate information, the historical conversion times of the candidate information (which may be the total conversion times or the conversion times in the recent time period) are obtained, the numerical interval in which the historical conversion times are located (assumed to be the s-th interval) is determined, and a popularity vector with the dimension of r is generated; the s-th element in the popularity vector is 1, and other dimensions are 0.

The characterization of popularity is spliced with other input features, and after conversion, it is used as the output of the gate network of the information layer, so that the following formula represents the output of the gate network of the information layer:

wₐ=Softmax(W₄(x_{g}⊕xₐ⊕eₚₒₚᵤ))

eₚₒₚᵤ represents the popularity vector, ⊕ is the splicing operation, and W₄∈ [symbol] is the parameter matrix of the gate network. Based on this lightweight design, the popularity of information may affect the characterization fusion more conveniently and directly.

For example, FIG. 7 shows a schematic diagram of obtaining the second weight according to an embodiment of the disclosure. As shown in FIG. 7, after the computer device splices the fine-grained feature 71, the coarse-grained feature 72 and the popularity vector 73 to obtain the spliced feature 74, the spliced feature 74 is input to the gate network 54b for processing to obtain the second weight 75 output by the gate network 54b.

The characterization vector of the information layer may be obtained by the following formula:

$${e}_{a} = {h}_{a} ( {f}_{a} )$$

$${f}_{a} = {\sum }_{k = 1}^{n} {w}_{a}^{k} {t}_{a}^{k} + {\sum }_{k = n + 1}^{n + m} {w}_{a}^{k} {t}_{g}^{k}$$

where m and n are the number of expert networks in the grouping layer and the information layer, and hₐ represents the tower-shaped network in the information layer.

After obtaining the first feature and the second feature, the computer device may obtain target information from at least two pieces (that is, from a plurality of pieces) of candidate information based on the first feature and the second feature, and the process may further include the following operations.

Operation 404. Fuse the first feature and the second feature to obtain a fused feature of the candidate information.

In one possible implementation, the process of fusing the first feature and the second feature to obtain the fused feature of the candidate information may include:
obtaining the third weight of the second feature based on the information feature; and
fusing the first feature and the second feature based on the third weight of the second feature to obtain the fused feature.

In an embodiment of the disclosure, when the computer device fuses the first feature and the second feature of the candidate information, after the second feature is weighted, it may be fused with the first feature where the third weight of the second feature is obtained through the information feature (the coarse-grained feature+the fine-grained feature) of the candidate information. The importance degree of the second feature with respect to the information feature and the influence degree of the second feature when generating the fused feature may be accurately embodied through the third weight, thereby effectively improving the accuracy of the fused feature.

In one possible implementation, the process of obtaining the third weight of the second feature based on the information feature may include:
obtaining the third weight of the second feature based on the information feature and the popularity vector.

In an embodiment of the disclosure, when calculating the third weight of the second feature of the candidate information, the influence of the popularity of the candidate information on the weight of the second feature may also be considered, so as to further improve the accuracy of the influence of the third weight during feature fusion.

In one possible implementation, the process of obtaining the third weight of the second feature based on the information feature and the popularity vector may include:
splicing the information feature and the popularity vector to obtain a second spliced feature of the candidate information; and
obtaining the third weight of the second feature based on the second spliced feature.

In an embodiment of the disclosure, when considering the influence of the popularity of the candidate information on the weight of the second feature, the popularity vector of the candidate information may be spliced with the information feature of the candidate information, so that the fusion degree of the popularity vector and the information feature may be improved by splicing, and the third weight is calculated based on the obtained spliced feature.

In one possible implementation, the process of fusing the first feature and the second feature based on the third weight of the second feature to obtain the fused feature may include:
weighting the second feature based on the second feature to obtain a weighted feature of the candidate information; and
adding the weighted feature and the first feature to obtain the fused feature.

After the second feature is weighted and when it is fused with the first feature, the weighted result between the second feature and the third weight may be added with the first feature to obtain the fused feature. By weighting, it may better reflect the indication function of the third weight on the importance degree of the second feature and improve the accuracy of the fused feature.

In one possible implementation, the process of fusing the first feature and the second feature to obtain the fused feature of the candidate information may include:
through the fusion branch in the probability estimation model, processing the first feature and the second feature to obtain the fused feature.

In an embodiment of the disclosure, the process of fusing the first feature and the second feature may be called dynamic characterization fusion. Referring to FIG. 5, in dynamic characterization fusion, the information layer characterization learns all information among different information, while the grouping layer characterization is particularly important for new information or information released by information publishers with less released information. In order to combine the two, a lightweight gate network (i.e., the gate network 55 in FIG. 5) may be used to self-adaptively synthesize their characterization. The process of feature synthesis may be represented by the following formula:

v_{fuse}=tanh(W₅(xₐ⊕eₚₒₚᵤ))

e=eₐ+v_{fuse}⊗e_{g}

where e∈ [symbol] is the final characterization vector output by the model, and e∈ [symbol] sub-tables are the characterization vectors of information layer and grouping layer. W₅∈ [symbol] is the coefficient matrix, W₅∈ [symbol] is the vector element product operation, W₅∈ [symbol] is the learned fusion weight vector (i.e., the third weight mentioned above), and W₅∈ [symbol] is the weighted feature.

The combination of information layer characterization and grouping layer characterization contains a lot of effective information, so that the final characterization of information has a stronger generalization ability, therefore, it may alleviate the impact brought by a cold start issue in event probability estimation after information display.

In an embodiment of the disclosure, the third weight is explained using a weight vector as an example. Optionally, the third weight may also be represented in various representation forms, for example, the third weight may also be a weight value.

Operation 405. Obtain the estimated event probability of the candidate information based on the fused feature; where the estimated event probability is configured to identify the estimated probability of the specified event after the corresponding information display.

The specified event may be at least one of a conversion event, a click event or an exposure event for candidate information.

In an embodiment of the disclosure, the computer device may estimate the probability that effective pushing meeting the specified issue may be generated after the candidate information is pushed and displayed (i.e., events such as conversion, click or exposure occur after pushing). The estimated event probability is related to the specific type of the specified event. For example, the estimated event probability may be at least one of the estimated conversion rate, the estimated click rate and the estimated exposure rate.

In one possible implementation, the process of obtaining the estimated event probability of candidate information based on the fused feature may include:
through the estimation branch in the probability estimation model, processing the fused feature to obtain the predicted event probability.

In an embodiment of the disclosure, as shown in FIG. 5, the probability estimation model may further include an estimation branch 56, and an input of the estimation branch 56 includes a fused feature of the candidate information. Optionally, the input of the estimation branch may also include other feature information, such as relevant features of a display position and relevant features of a user corresponding to the display position (i.e., the characterization vector output by the user side), which is not limited thereto. Based on all kinds of information sharing of the above-mentioned probability estimation model, the accuracy of estimating event probability may be guaranteed through the estimation branch of the probability estimation model, and the information pushing efficiency may be improved.

In an embodiment of the disclosure, the computer device may also train the probability estimation model before obtaining the candidate information.

In one possible implementation, the training process of the probability estimation model may be as follows:
extracting an information feature of sample information;
processing a coarse-grained feature of the sample information through a first extraction branch to obtain a first feature of the sample information;
processing information feature and an intermediate feature of the sample information through a second extraction branch to obtain a second feature of the sample information;
processing the first feature of the sample information and the second feature of the sample information through a fusion branch to obtain a fused feature of the sample information;
processing the fused feature of the candidate information through the estimation branch in the probability estimation model to obtain an estimated event probability of the sample information;
obtaining a loss function value based on the estimated event probability of the sample information, an event probability label of the sample information and a training weight of the sample information; where the training weight is inversely related to the popularity of the sample information; and the event probability label is used for indicating a labeling probability that a specified event occurs after the sample information is displayed; and
updating parameters of the probability estimation model based on the loss function value.

The computer device may regularly collect a pushing situation of various information in the network within a certain period of time (for example, within 48 hours before the current moment), such as whether it is pushed, and whether click, exposure and conversion events occur after pushing, and construct the sample information and the labeling probability of the sample information based on the pushing situation of various information in the network.

In an embodiment of the disclosure, the probability estimation model may focus on learning an optimal characterization vector for each information, and a multi-layer neural network may be adopted to learn the characterization vector of the user. Taking the estimated event probability to be a conversion rate estimated value as an example, the estimated conversion rate estimated value may be represented as:

ŷ_{ι}=Sigmoid(e·eᵤ)

eᵤ is the characterization vector output by the user side.

In an embodiment of the disclosure, a logarithmic loss may be used as the loss function. The logarithmic loss is a common loss function in conversion rate estimation. Because the positive samples in a real data set may be gathered on a little information with high popularity, in order to prevent the loss function from being influenced by these samples too much, in an embodiment of the disclosure, the loss function is optimized as follows:

$$Logloss = - {\sum }_{i = 1}^{N} {w}_{i} ( {y}_{i} log ( \hat{{y}_{ι}} ) + ( 1 - {y}_{i} ) log ( 1 - \hat{{y}_{ι}} ) )$$

yᵢ and ŷᵢ represent an actual value of user conversion and an estimated value of the conversion rate, respectively, wᵢ is the weight value of training sample i, and N is the total number of training samples. The significance of introducing weight into the loss function is that it may appropriately reduce the sensitivity of loss to popularity advertisements and further focus on new advertisements.

Optionally, the formula for calculating the weight of the training sample is:

$${w}_{i} = \frac{1}{\sqrt{{K}_{i} + 1}}$$

Kᵢ represents the popularity of training sample i, for example, Kᵢ may be the number of historical conversion times of training sample i. In an embodiment of the disclosure, the weight difference between the advertisement with higher popularity and the new advertisement with lower popularity may reach two orders of magnitude, which will lead to unsatisfactory training results. Therefore, in an embodiment of the disclosure, Kᵢ may be truncated, for example, the maximum value of Kᵢ is set to 20.

Operation 406. Obtain target information from at least two pieces of candidate information based on the estimated event probability.

In an embodiment of the disclosure, the computer device may rank at least two pieces (that is, a plurality of pieces) of candidate information from large to small according to the estimated event probability, and select one or more candidate information ranked at the forefront as the target information.

Operation 407. Push the target information.

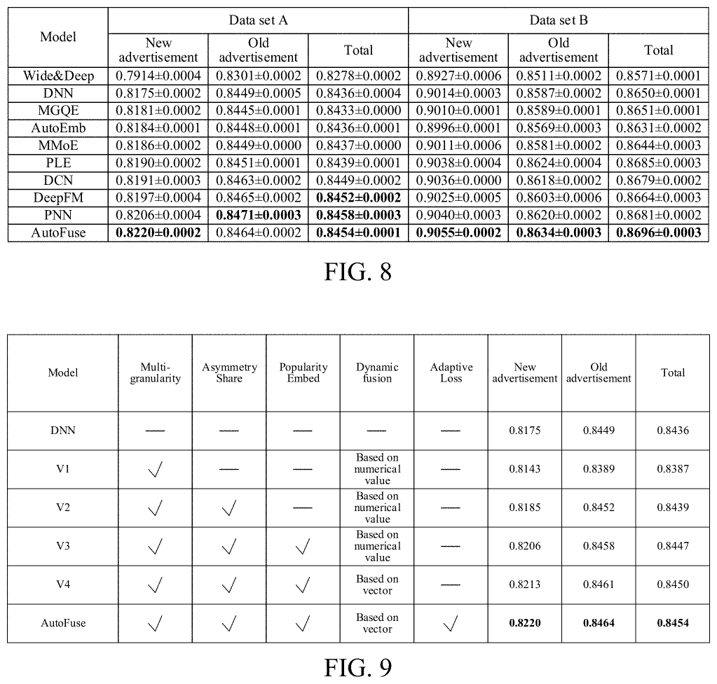

FIG. 8 shows the schematic diagram of the comparative experiment results according to an embodiment of the disclosure.

FIG. 8 shows the results obtained by applying certain embodiments of the disclosure to two different advertising product data sets. All the experimental results consist of the mean and variance of an Area Under Curve (AUC) in three repeated experiments. The best results are displayed in bold.

As may be seen by observing FIG. 8:
(1) Compared with Multi-Granular Quantized Embedding (MGQE) and Automatic Embedding Model (AutoEmb), AutoFuse (i.e., the probability estimation model provided by an embodiment of the disclosure) adopts a higher-level modeling technology, so it has better results in both old and new advertisements.
(2) Compared with a Deep Feature Embedding (DeepFM) model, a Product-based Neural Networks (PNN) model and a Deep and Cross Network (DCN) model, various embodiments of the disclosure have clear advantages in new advertisements and also show comparable competitiveness in old advertisements, all of which benefit from feature grouping and asymmetric sharing.
(3) Compared with a Multi-Gate Mixture-Of-Experts (MMOE) model and Progressive Layered Extraction (PLE), i.e., the two multi-task models, the bottom feature grouping construction of AutoFuse greatly reduces the training pressure of the upper structure, enabling it to more focus on the characterization learning of different layers, thus improving the generalization performance.
(4) AutoFuse fully explores the mode feature among individuals and groups of advertisements, and provides an effective solution for the cold start issue of advertisement estimated conversion rate. Compared with Deep Neural Networks (DNN), it achieves 0.55% and 0.46% performance improvements on new advertisements of two data sets, respectively. On the two data sets of the old advertisement, various embodiments of the disclosure have also achieved 0.18% and 0.21% improvement, and on the two data sets of the overall advertisement, the AutoFuse has achieved 0.55% and 0.53% improvement respectively. 0.1% AUC improvement may be considered as a significant improvement in industry; these achievements fully prove that various embodiments of the disclosure may both alleviate the cold start issue and obtain an overall improvement of performance.

FIG. 9 shows the schematic diagram of ablation experiment results according to an embodiment of the disclosure. In order to further verify the AutoFuse model, more ablation experiments are carried out based on various embodiments of the disclosure to compare various variants of AutoFuse.

Various embodiments of the disclosure adopt the strategy of feature grouping and asymmetric sharing. Firstly, the input features are grouped, and the information layer is completely isolated from the grouping layer. The expert network of the information layer only inputs a fineness feature, and the gate network of the information layer also only fuses the expert network of the information layer. In an output part of the information layer and the grouping layer, numerical value based fusion is adopted, so that the final output of the whole system is the weighted sum of the information layer and grouping layer. The variant is labeled “V1” in FIG. 9.

In an embodiment of the disclosure, variant “V2” in FIG. 9 adds asymmetric sharing on the basis of V1. The performance is greatly improved from V1 to V2, demonstrating the advantage of asymmetric sharing. V2 is 0.75% higher than V1 in the old advertisements, demonstrating that it is advantageous to add the coarse-grained feature in the information layer. More importantly, V2 has clear advantages over DNN, which reflects relative rationality of the mode of using asymmetric sharing to fuse features.

Various embodiments of the disclosure also consider popularity embedding characterization. The correlation between the features of the information layer and grouping layer is very complex and will be affected by sample distribution. Accordingly, AutoFuse uses popularity embedding characterization to self-adaptively guide this fusion, resulting in the variant labeled as V3 in FIG. 9. Compared with V2, V3 achieves an increase of 0.26% in AUC of new advertisements, and the performance of old advertisements is similar to that of V2, which indicates that popularity embedding facilitates the performance of new advertisements more. This phenomenon is also in line with an expectation of the disclosure, because the old advertisements have a large amount of training data and may learn meaningful characterizations, while the new advertisements operate on more direct guidance to obtain knowledge and fuse characterization information.

Various embodiments of the disclosure also adopt the strategy of dynamic fusion and self-adaptive loss. Dynamic fusion is to self-adaptively combine the characterization output of the information layer and grouping layer. The weighted sum method based on numerical values may reduce the order of magnitude of each vector. AutoFuse adopts vector-based fusion, which gives different weight values to different dimensions of input vectors. This method is more flexible and may introduce more nonlinearity, and the resulting model is labeled as V4 in FIG. 9. V4 shows improvement over V3 in both old and new advertisements. On the basis of V4, AutoFuse also adds self-adaptive loss, and its effect on new advertisements is also further improved.

To sum up, in various embodiments of the disclosure, the information feature is divided into the coarse-grained feature with a large number of tail value samples and the fine-grained feature with a small number of tail value samples, and the first feature is extracted from the coarse-grained feature, and the second feature is extracted from the complete information feature. Moreover, when extracting the second feature, the second feature is extracted by combining the intermediate feature between the coarse-grained feature and the first feature, multi-level feature characterization may be learned synchronously from the information feature, so that the characterization effect of the extracted features on the information may be improved, and the accuracy of information pushing may be improved when information is selected and pushed through the extracted first feature and second feature.

Various embodiments of the disclosure may be realized or executed in combination with a blockchain. For example, some or all of the operations in the various embodiments may be performed in a blockchain system; or, data used for the execution of each operation in the various embodiments or the generated data may be stored in the blockchain system; for example, the model input data such as the training samples used during model training and the candidate information in the model application process may be obtained from the blockchain system by the computer device; for another example, the parameters of the model obtained after the model training may be stored in the blockchain system.

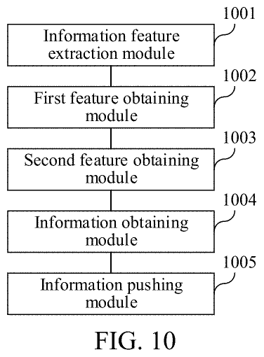

FIG. 10 is a structural block diagram of an information pushing device according to an exemplary embodiment. The apparatus may realize all or part of the operations in the method provided by the embodiment shown in FIG. 2 or FIG. 4, and the information pushing apparatus includes:
an information feature extraction module 1001, configured to extract information feature of candidate information, where the information feature includes a coarse-grained feature and a fine-grained feature; where the number of tail value samples of the coarse-grained feature is greater than that of the fine-grained feature;
a first feature obtaining module 1002, configured to obtain a first feature of the candidate information based on the coarse-grained feature; where the first feature is obtained based on an intermediate feature; and the intermediate feature is obtained in the process of extracting the coarse-grained feature;
a second feature obtaining module 1003, configured to obtain a second feature of the candidate information based on the information feature and the intermediate feature;
an information obtaining module 1004, configured to obtain target information from at least two of the candidate information based on the first feature and the second feature; and
an information pushing module 1005, configured to push the target information.

In one possible implementation, the first feature obtaining module 1002 is configured to,
perform feature extraction on the coarse-grained feature to obtain m first intermediate features of the candidate information; where m is a positive integer;
obtain a first weight of the m first intermediate features based on the coarse-grained feature; and
obtain a first feature of the candidate information based on the m first intermediate features and the first weight of the m first intermediate features.

In one possible implementation, the second feature obtaining module 1003 is configured to,
perform feature extraction on the information feature to obtain n second intermediate features of the candidate information; where n is a positive integer;
obtain a second weight of the n second intermediate features and a second weight of the m first intermediate features based on the information feature; and
obtain a second feature of the candidate information based on the second weight of the n second intermediate features, the second weight of the m first intermediate features, the n second intermediate features and the m first intermediate features.

In one possible implementation, the second feature obtaining module 1003 is configured to obtain the second weight of the n second intermediate features and the second weight of the m first intermediate features based on the information feature and the popularity vector of the candidate information; where the popularity vector is used for indicating historical conversion times of the candidate information.

In one possible implementation, the second feature obtaining module 1003 is configured to,
splice the information feature and the popularity vector to obtain a first spliced feature of the candidate information; and
obtain the second weight of the n second intermediate features and the second weight of the m first intermediate features based on the first spliced features.

In a possible implementation, the information obtaining module 1004 is configured to:
fuse the first feature and the second feature to obtain a fused feature of the candidate information;
obtain an estimated event probability of the candidate information based on the fused feature; where the estimated event probability is used for identifying an estimated probability of a specified event after corresponding information is displayed; and
obtain the target information from at least two pieces of candidate information based on the estimated event probability.

In a possible implementation, the information obtaining module 1004 is configured to:
obtain the third weight of the second feature based on the information feature; and
fuse the first feature and the second feature based on the third weight of the second feature to obtain the fused feature.

In a possible implementation, the information obtaining module 1004 is configured to:
obtain the third weight of the second feature based on the information feature and the popularity vector.

In a possible implementation, the information obtaining module 1004 is configured to:
splice the information feature and the popularity vector to obtain a second spliced feature of the candidate information; and
obtain the third weight of the second feature based on the second spliced feature.

In a possible implementation, the information obtaining module 1004 is configured to:
weight the second feature based on the second feature to obtain a weighted feature of the candidate information; and
add the weighted feature and the first feature to obtain the fused feature.

In one possible implementation, the first feature obtaining module 1002 is configured to process the coarse-grained feature through a first extraction branch in a probability estimation model to obtain the first feature;
the second feature obtaining module 1003 is configured to process the information feature and the intermediate feature through a second extraction branch in the probability estimation model to obtain the second feature;
the information obtaining module 1004 is configured to process the first feature and the second feature through a fusion branch in the probability estimation model to obtain the fused feature; and
the information obtaining module 1004 is configured to process the fused feature through an estimation branch in the probability estimation model to obtain the estimated event probability.

In a possible implementation, the apparatus further includes:
the information feature extraction module 1001, further configured to extract the information feature of the sample information before extracting the information feature of the candidate information;
the first feature obtaining module 1002, further configured to process the coarse-grained feature of the sample information through the first extraction branch to obtain a first feature of the sample information;
the second feature obtaining module 1003, further configured to process the information feature of the sample information and the intermediate feature of the sample information through the second extraction branch to obtain a second feature of the sample information;
the information obtaining module 1004, further configured to process the first feature of the sample information and the second feature of the sample information through the fusion branch to obtain a fused feature of the sample information; and
the information obtaining module 1004, further configured to process the fused feature of the candidate information through the estimation branch in the probability estimation model to obtain the estimated event probability of the sample information.

The apparatus further includes:
a loss function value obtaining module, configured to obtain a loss function value based on the estimated event probability of the sample information, an event probability label of the sample information, and a training weight of the sample information; where the training weight is inversely related to the popularity of the sample information; and the event probability label is used for indicating a labeling probability of the specified event after the sample information is displayed; and
a parameter updating module, configured to update parameters of the probability estimation model based on the loss function value.

To sum up, in various embodiments of the disclosure, the information feature is divided into the coarse-grained feature with a large number of tail value samples and the fine-grained feature with a small number of tail value samples, and the first feature is extracted from the coarse-grained feature, and the second feature is extracted from the complete information feature. Moreover, when extracting the second feature, the second feature is extracted by combining the intermediate feature between the coarse-grained feature and the first feature, multi-level feature characterization may be learned synchronously from the information feature, so that the characterization effect of the extracted features on the information may be improved, and the accuracy of information pushing may be improved when information is selected and pushed through the extracted first feature and second feature.

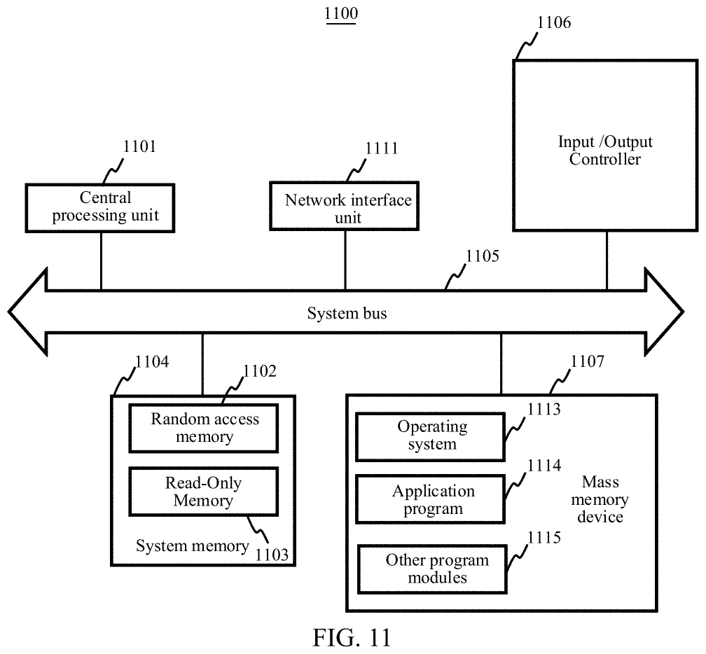

FIG. 11 is a schematic structural diagram of a computer device according to an exemplary embodiment. The computer device may be realized as a computer device for training a first image recognition model in the above-mentioned various method embodiments, or may be realized as a computer device for recognizing brain midline through a second image recognition model in the above-mentioned various method embodiments. The computer device 1100 includes a Central Processing Unit (CPU) 1101, a system memory 1104 including a Random Access Memory (RAM) 1102 and a Read-Only Memory (ROM) 1103, and a system bus 1105 connecting the system memory 1104 to the CPU 1101. The computer device 1100 further includes a basic input/output (I/O) system 1106 assisting in transmitting information between devices in the computer, and a mass storage device 1107 for storing an operating system 1113, an application program 1114, and other program modules 1115.

The mass storage device 1107 is connected to the CPU 1101 by using a mass storage controller (not shown) connected to the system bus 1105. The mass storage device 1107 and a computer-readable medium associated therewith provide non-volatile storage for the computer device 1100. That is to say, the mass storage device 1107 may include a computer-readable medium (not shown) such as a hard disk or a Compact Disc Read-Only Memory (CD-ROM) drive.

In general, the computer-readable medium may include a computer storage medium and a communications medium. The computer storage medium includes volatile and non-volatile media, and removable and non-removable media implemented by using any method or technology used for storing information such as computer-readable instructions, data structures, program modules, or other data. The computer storage medium includes RAM, ROM, flash memory or other solid-state storage technologies, CD-ROM, or other optical storage, magnetic tape cassettes, magnetic tapes, magnetic disk storage or other magnetic storage devices. A person skilled in the art will understand that the computer storage medium is not limited to the foregoing several types. The system memory 1104 and the mass storage device 1107 may be collectively described as a memory.

The computer device 1100 may be connected to the Internet or other network devices through a network interface unit 1111 connected to the system bus 1105.

The memory further includes one or more programs. The one or more programs are stored in the memory. The CPU 1101 implements all or partial operations of the method shown in FIG. 2 or FIG. 4 by executing the one or more programs.

In an exemplary embodiment, a non-transitory computer-readable storage medium including an instruction is further provided, for example, a memory including a computer program (an instruction), and the foregoing program (instruction) may be executed by a processor of the computer device to complete the methods shown in various embodiments of the disclosure. For example, the non-transitory computer-readable storage medium may be a Read-Only Memory (ROM), a Random Access Memory (RAM), a Compact Disc Read-Only Memory (CD-ROM), a magnetic tape, a floppy disk, an optical data storage device, and the like.

In an exemplary embodiment, a computer program product or computer program including computer instructions stored in a computer-readable storage medium is also provided. The processor of the computer device reads the computer instructions from the computer-readable storage medium, and the processor executes the computer instructions, so that the computer device performs the method shown in the above-mentioned various embodiments.

The technical solutions provided in the embodiments of the disclosure have beneficial effects including, but not limited to: An information feature is divided into a coarse-grained feature with a large number of tail value samples and a fine-grained feature with a small number of tail value samples. A first feature is extracted from the coarse-grained feature, and a second feature is extracted from information feature including the coarse-grained feature and the fine-grained feature. When extracting the second feature, the second feature is extracted by combining an intermediate feature between the coarse-grained feature and the first feature, and multi-level feature characterization is synchronously learned from the information feature. Therefore, a characterization effect of the extracted feature on candidate information at multiple granularities may be improved, target information for pushing may be accurately obtained from the candidate feature through the first feature and the second feature, and the accuracy of information pushing may be improved.

After considering and practicing the present disclosure, a person skilled in the art may easily conceive of other implementations thereof. This disclosure is intended to cover any variations, uses, or adaptive changes thereof. These variations, uses, or adaptive changes follow the general principles of the disclosure and include common general knowledge or common technical means in the art, which are not disclosed herein. The disclosed embodiments are considered as merely exemplary, and the scope and spirit of the disclosure are pointed out in the following claims.

It should be understood that the disclosure is not limited to the precise structures described above and shown in the accompanying drawings, and various modifications and changes may be made without departing from the scope of the disclosure, which is subject only to the appended claims.

What is claimed is:

1. An information pushing method, performed by at least one processor and comprising:
extracting an information feature of candidate information, the information feature comprising a coarse-grained feature and a fine-grained feature, a number of tail value samples of the coarse-grained feature being greater than a number of tail value samples of the fine-grained feature;
obtaining a first feature of the candidate information based on an intermediate feature, the intermediate feature being obtained in a process of extracting the coarse-grained feature;
obtaining a second feature of the candidate information based on the information feature and the intermediate feature;
obtaining target information from a plurality of pieces of candidate information, based on the first feature and the second feature; and
pushing the target information.

2. The method according to claim 1, wherein the obtaining of the first feature comprises:
performing feature extraction on the coarse-grained feature to obtain at least one first intermediate feature of the candidate information;
obtaining a first weight of each of the at least one first intermediate feature based on the coarse-grained feature; and
obtaining the first feature of the candidate information based on the at least one first intermediate feature and the first weight of each of the at least one first intermediate feature.

3. The method according to claim 2, wherein the obtaining of the second feature comprises:
performing feature extraction on the information feature to obtain at least one second intermediate feature of the candidate information;
obtaining second weights based on the information feature, the second weights comprising a second weight of each of the at least one second intermediate feature and a second weight of each of the at least one first intermediate feature; and
obtaining the second feature of the candidate information based on the second weight of each of the at least one second intermediate feature, the second weight of each of the at least one first intermediate feature, the at least one second intermediate feature, and the at least one first intermediate feature.

4. The method according to claim 3, wherein the obtaining of the second weights is further based on a popularity vector of the candidate information, the popularity vector indicating historical conversion times of the candidate information.

5. The method according to claim 4, wherein the obtaining of the second weights comprises:
splicing the information feature and the popularity vector to obtain a first spliced feature of the candidate information; and
obtaining the second weights based on the first spliced feature.

6. The method according to claim 1, wherein the obtaining of the target information comprises:
fusing the first feature and the second feature to obtain a fused feature of the candidate information;
obtaining an estimated event probability of the candidate information based on the fused feature, the estimated event probability marking an estimated probability of a specified event after corresponding information is displayed; and
obtaining the target information based on the estimated event probability.

7. The method according to claim 6, wherein the fusing of the first feature and the second feature comprises:
obtaining a third weight of the second feature based on the information feature; and
fusing the first feature and the second feature based on the third weight of the second feature to obtain the fused feature.

8. The method according to claim 7, wherein the obtaining of the third weight is further based on a popularity vector of the candidate information, the popularity vector indicating historical conversion times of the candidate information.

9. The method according to claim 8, wherein the obtaining of the third weight comprises:
splicing the information feature and the popularity vector to obtain a second spliced feature of the candidate information; and
obtaining the third weight of the second feature based on the second spliced feature.

10. The method according to claim 7, wherein the fusing of the first feature and the second feature comprises:
weighting the second feature based on the second feature to obtain a weighted feature of the candidate information; and
adding the weighted feature and the first feature to obtain the fused feature.

11. The method according to claim 6, wherein:
the obtaining of the first feature comprises processing the coarse-grained feature through a first extraction branch in a probability estimation model;
the obtaining of the second feature comprises processing the information feature and the intermediate feature through a second extraction branch in the probability estimation model;
the obtaining of the fused feature comprises processing the first feature and the second feature through a fusion branch in the probability estimation model; and
the obtaining of the estimated event probability comprises processing the fused feature through an estimation branch in the probability estimation model.

12. The method according to claim 11, further comprising, before extracting the information feature of the candidate information:
extracting an information feature of sample information;
processing the coarse-grained feature of the sample information through the first extraction branch to obtain a first feature of the sample information;
processing the information feature of the sample information and the intermediate feature of the sample information through the second extraction branch to obtain a second feature of the sample information;
processing the first feature of the sample information and the second feature of the sample information through the fusion branch to obtain a fused feature of the sample information;
processing the fused feature of the candidate information through the estimation branch in the probability estimation model to obtain an estimated event probability of the sample information;
obtaining a loss function value based on the estimated event probability of the sample information, an event probability label of the sample information, and a training weight of the sample information, the training weight being inversely related to a popularity of the sample information, the event probability label indicating a labeling probability of the specified event after the sample information is displayed; and
updating a parameter of the probability estimation model based on the loss function value.

13. An information pushing apparatus, comprising:
at least one memory configured to store program code; and
at least one processor configured to read the program code and operate as instructed by the program code, the program code comprising:
information feature extraction code, configured to cause the at least one processor to extract information feature of candidate information, the information feature comprising a coarse-grained feature and a fine-grained feature, a number of tail value samples of the coarse-grained feature being greater than a number of tail value samples of the fine-grained feature;
first feature obtaining code, configured to cause the at least one processor to obtain a first feature of the candidate information based on an intermediate feature, the intermediate feature being obtained in a process of extracting the coarse-grained feature;
second feature obtaining code, configured to cause the at least one processor to obtain a second feature of the candidate information based on the information feature and the intermediate feature;
information obtaining code, configured to cause the at least one processor to obtain target information from a plurality of pieces of the candidate information based on the first feature and the second feature; and
information pushing code, configured to cause the at least one processor to push the target information.

14. The apparatus according to claim 13, wherein the first feature obtaining code causes the at least one processor to obtain the first feature by:
performing feature extraction on the coarse-grained feature to obtain at least one first intermediate feature of the candidate information,
obtaining a first weight of each of the at least one first intermediate feature based on the coarse-grained feature, and
obtaining the first feature of the candidate information based on the at least one first intermediate feature and the first weight of each of the at least one first intermediate feature; and
wherein the second feature obtaining code causes the at least one processor to obtain the second feature by:
performing feature extraction on the information feature to obtain at least one second intermediate feature of the candidate information,
obtaining second weights based on the information feature, the second weights comprising a second weight of each of the at least one second intermediate feature and a second weight of each of the at least one first intermediate feature, and
obtaining the second feature of the candidate information based on the second weight of each of the at least one second intermediate feature, the second weight of each of the at least one first intermediate feature, the at least one second intermediate feature, and the at least one first intermediate feature.

15. The apparatus according to claim 14, wherein the second feature obtaining code causes the at least one processor to obtain the second weights by:
splicing the information feature and a popularity vector to obtain a first spliced feature of the candidate information, the popularity vector indicating historical conversion times of the candidate information; and
obtaining the second weights based on the first spliced feature.

16. The apparatus according to claim 13, wherein the information obtaining code causes the at least one processor to obtain the target information by:
fusing the first feature and the second feature to obtain a fused feature of the candidate information;
obtaining an estimated event probability of the candidate information based on the fused feature, the estimated event probability marking an estimated probability of a specified event after corresponding information is displayed; and
obtaining the target information based on the estimated event probability.

17. The apparatus according to claim 16, wherein the information obtaining code causes the at least one processor to fuse the first feature and the second feature by:
obtaining a third weight of the second feature based on the information feature; and
fusing the first feature and the second feature based on the third weight of the second feature to obtain the fused feature.

18. The apparatus according to claim 17, wherein the information obtaining code causes the at least one processor to obtain the third weight by:
splicing the information feature and a popularity vector to obtain a second spliced feature of the candidate information, the popularity vector indicating historical conversion times of the candidate information; and
obtaining the third weight of the second feature based on the second spliced feature.

19. The apparatus according to claim 17, wherein the information obtaining code causes the at least one processor to fuse the first feature and the second feature by:
weighting the second feature based on the second feature to obtain a weighted feature of the candidate information; and
adding the weighted feature and the first feature to obtain the fused feature.

20. A non-transitory computer-readable storage medium, storing at least one computer instruction, wherein the at least one computer instruction is executable by at least one processor to cause the at least one processor to:
extract an information feature of candidate information, the information feature comprising a coarse-grained feature and a fine-grained feature, a number of tail value samples of the coarse-grained feature being greater than a number of tail value samples of the fine-grained feature;
obtain a first feature of the candidate information based on an intermediate feature, the intermediate feature being obtained in a process of extracting the coarse-grained feature;
obtain a second feature of the candidate information based on the information feature and the intermediate feature;
obtain target information from a plurality of pieces of candidate information, based on the first feature and the second feature; and
push the target information.
